(19) United States
(12) Patent Application Publication
(10) Pub. No.: US 2010/0265173 A1
(43) Pub. Date: Oct. 21, 2010

(54) INFORMATION PROCESSING PROGRAM AND INFORMATION PROCESSING APPARATUS

(75) Inventor: Hiroshi MATSUNAGA, Kyoto-shi (JP)

Correspondence Address: NIXON & VANDERHYE, P.C., 901 NORTH GLEBE ROAD, 11TH FLOOR, ARLINGTON, VA, 22203, US

(73) Assignee: NINTENDO CO., LTD., Kyoto (JP)

(21) Appl. No.: 12/633,381

(22) Filed: Dec. 8, 2009

(30) Foreign Application Priority Data
Apr. 20, 2009 (JP) 2009-101511

(51) Int. Cl. G06F 3/033

(52) U.S. Cl. 345/157

(57) ABSTRACT

A game apparatus being one example of an information processing apparatus includes a CPU. The CPU detects a coordinate position designated on a monitor screen on the basis of a signal from a controller to be operated by a user, detects a barycentric position of the user on the basis of a signal from a load controller on which the user rides, and performs processing in relation to a test on a balance function and progress of the game on the basis of the detected coordinate position and the detected barycentric position.

### CROSS REFERENCE OF RELATED APPLICATION

The disclosure of Japanese Patent Application No. 2009-101511 is incorporated herein by reference.

### BACKGROUND OF THE INVENTION

1. Field of the Invention

The present invention relates to an information processing program and an information processing apparatus. More specifically, the present invention relates to an information processing program and an information processing apparatus which perform predetermined processing on the basis of a barycentric position of a user.

2. Description of the Related Art

As an apparatus or a program of such a kind, a document disclosed in Japanese Patent Application Laid-Open No. 2005-334083 (Patent Document 1) is known, for example. In the background art, a movement of gravity associated with walking by a user is detected by a detection plate, and a balance function at a time of walking is detected on the basis of the detection result.

However, in the background art of the Patent Document 1, information processing is performed by only noticing the movement of the gravity, so that only the balance function at a time of a simple action, such as at walking is detected.

### SUMMARY OF THE INVENTION

Therefore, it is a primary object of the present invention to provide a novel information processing program and an information processing apparatus.

Another object of the present invention is to provide an information processing program and an information processing apparatus which are able to test a balance function even at a time of complex motions.

The present invention adopts the following configuration in order to the above-described problems.

A first invention is an information processing program causing a computer of an information processing apparatus to execute a coordinate position detecting step for detecting a coordinate position on a screen on the basis of a signal from a coordinate input means to be operated by a user, a barycentric position detecting step for detecting a barycentric position of the user on the basis of a signal from a barycentric position detecting means, and a processing step for performing predetermined processing on the basis of the coordinate position detected by the coordinate position detecting step and the barycentric position detected by the barycentric position detecting step.

In the first invention, an information processing program causes a computer of an information processing apparatus to execute a coordinate position detecting step, a barycentric position detecting step, and a processing step. The coordinate position detecting step detects a coordinate position on the basis of a signal from a coordinate input means to be operated by a user. The barycentric position detecting step detects a barycentric position of the user on the basis of a signal from a barycentric position detecting means. The processing step performs predetermined processing on the basis of the coordinate position detected by the coordinate position detecting step and the barycentric position detected by the barycentric position detecting step.

According to the first invention, the barycentric position of the user is moved in accordance with an operation of the coordinate input means while the information processing apparatus executes the predetermined processing on the basis of the coordinate position and the barycentric position, and therefore, by including the processing in relation to testing the balance function in the predetermined processing, it is possible to test the balance function even at a time of complex motions, such as an operation of the coordinate input means.

A second invention is an information processing program according to the first invention, and the processing step performs the predetermined processing on the basis of the coordinate position detected by the coordinate position detecting step when the barycentric position detected by the barycentric position detecting step is within a predetermined range (within a central circle, for example).

In the second invention, in order to cause the information processing apparatus to execute the predetermined processing, the user is required to have the skills of operating the coordinate input means, and moving the body weight so as not to extend the barycentric position off the predetermined range at the same time. Thus, the user can perform the game without being tired thereof. Furthermore, by including the processing in relation to the progress of a game in the predetermined processing, it is possible to perform the test as if the player plays the game.

A third invention is an information processing program according to the second invention, and the information processing program causes the computer to further execute an image displaying step for displaying a designation image to be designated by the user when the barycentric position detected by the barycentric position detecting step is within the predetermined range, and the processing step performs a specific processing when the coordinate position detected by the coordinate position detecting step enters the range corresponding to the designation image displayed by the image displaying step.

In the third invention, the information processing program causes the computer to further execute an image displaying step. The image displaying step displays a designation image (numeral button, for example) to be designated by the user when the barycentric position detected by the barycentric position detecting step is within the predetermined range. The processing step performs a specific process when the coordinate position detected by the coordinate position detecting step is within the range corresponding to the designation image displayed by the image displaying step.

A fourth invention is an information processing program according to the third invention, and the information processing program causes the computer to further execute an image erasing step for erasing the designation image displayed by the image displaying step when the barycentric position detected by the barycentric position detecting step is off the predetermined range after the image displaying step displays the designation image.

In the fourth invention, the information processing program causes the computer to further execute an image erasing step. The image erasing step erases the designation image displayed by the image displaying step when the barycentric position detected by the barycentric position detecting step is off the predetermined range after the image displaying step displays the designation image.

According to the third and fourth inventions, when the barycentric position is within the predetermined range, the designation image is displayed, and if there is an input to the displayed designation image, specific processing (game succeeding processing of changing a numeral button on which an input is performed from color display to gray display, for example) is performed, so that it is possible to add an element of the game, such as performing an input to the designation image by the coordinate input device with the barycentric position within the predetermined range.

A fifth invention is an information processing program according to the third invention, and the image displaying step displays a plurality of designation images when the barycentric position detected by the barycentric position detecting step is within the predetermined range.

According to the fifth invention, it is possible to select the plurality of designation images to be input, capable of expanding in the game.

A sixth invention is an information processing program according to the fifth invention, and the image displaying step displays the plurality of designation images to each of which a size is set when the barycentric position detected by the barycentric position detecting step is within the predetermined range.

According to the sixth invention, the designation images are different in size, so that it is possible to change difficulty of the selection of the designation images.

A seventh invention is an information processing program according to the fifth invention, and the image displaying step displays plurality of designation images to each of which an order is set when the barycentric position detected by the barycentric position detecting step is within the predetermined range, and the processing step performs the specific processing when the coordinate position detected by the coordinate position detecting step enters a range corresponding to the designation image in an order set to the designation images displayed by the image displaying step.

In the seventh invention, the selecting order of the designation images is set, so that the difficulty of the game is enhanced, and it becomes possible to perform a test while an operation pattern (movement of the hands, for example) of the coordinate input means by the user are controlled.

An eighth invention is an information processing program according to the second invention, and the image displaying step displays an image corresponding to the predetermined range on the screen and the designation image around the image corresponding to the predetermined range.

A ninth invention is an information processing program according to the eighth invention, and the image displaying step displays the image corresponding to the predetermined range at approximately a center of a predetermined region of the screen, and displays the designation image around the image corresponding to the predetermined range.

In the eighth and ninth inventions, the designation image is displayed around the image corresponding to the predetermined range, so that the user can view the image corresponding to the predetermined range in a central field and the designation image in a peripheral field at the same time, capable of enhancing difficulty of the operation and the weight shift.

A tenth invention is an information processing program according to the first invention, and the information processing program causes the computer to further execute a pointer displaying step for displaying a coordinate position pointer to indicate the coordinate position detected by the coordinate position detecting step and a barycentric position pointer indicating the barycentric position detected by the barycentric position detecting step on the screen.

In the tenth invention, an information processing program causes the computer to further execute a pointer displaying step. The pointer displaying step displays a coordinate position pointer to indicate the coordinate position detected by the coordinate position detecting step and a barycentric position pointer indicating the barycentric position detected by the barycentric position detecting step on the screen.

According to the tenth invention, by displaying the two pointers, it is possible to cause the user to precisely perform the operations and the weight shift.

An eleventh invention is an information processing program according to the tenth invention, and the pointer displaying step displays the barycentric position pointer within the image corresponding to the predetermined range when the barycentric position detected by said barycentric position detecting step shows that the user is at balance.

A twelfth invention is an information processing apparatus comprising: a coordinate position detecting means for detecting a coordinate position on a screen on the basis of a signal from a coordinate input means to be operated by a user; a barycentric position detecting means for detecting a barycentric position of the user on the basis of a signal from a barycentric position detecting means; and a processing means for performing predetermined processing on the basis of the coordinate position detected by the coordinate position detecting means and the barycentric position detected by the barycentric position detecting means.

A thirteenth invention is an information processing method comprising: a coordinate position detecting step for detecting a coordinate position on a screen on the basis of a signal from a coordinate input means to be operated by a user; a barycentric position detecting step for detecting a barycentric position of the user on the basis of a signal from a barycentric position detecting means; and a processing step for performing predetermined processing on the basis of the coordinate position detected by the coordinate position detecting step and the barycentric position detected by the barycentric position detecting step.

In the twelfth or thirteenth invention as well, similar to the first invention, it becomes possible to test the balance function even at a time of complex motions.

According to the present invention, it is possible to implement an information processing program and an information processing apparatus capable of testing the balance function even at a time of the complex motions.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing one embodiment of a game system of the present invention;

FIG. 2 is a block diagram showing an electric configuration of the game system;

FIG. 3 is an illustrative view showing an appearance of a controller;

FIG. 4 is a block diagram showing an electric configuration of the controller;

FIG. 5 is an illustrative view showing an appearance of a load controller;

FIG. 6 is a cross-sectional view of the load controller;

FIG. 7 is a block diagram showing an electric configuration of the load controller;

FIG. 8 is an illustrative view showing a situation in which a virtual game is played by utilizing the controller and the load controller;

FIG. 9 is an illustrative view showing viewing angles of markers and the controller;

FIG. 10 is an illustrative view showing one example of an imaged image by the controller;

FIG. 11 is an illustrative view showing one example of a game screen;

FIG. 12 is an illustrative view showing another example of the game screen;

FIG. 13 is an illustrative view showing a still another example of the game screen;

FIG. 14 is an illustrative view showing a further example of the game screen;

FIG. 15 is an illustrative view showing another example of the game screen;

FIG. 16 is an illustrative view showing a still another example of the game screen;

FIG. 17 is an illustrative view showing one example of a memory map;

FIG. 18 is a flowchart showing a part of an operation of a CPU;

FIG. 19 is a flowchart showing another part of the operation of the CPU; and

FIG. 20 is a flowchart showing still another part of the operation of the CPU.

### DETAILED DESCRIPTION OF THE PREFERRED EMBODIMENTS

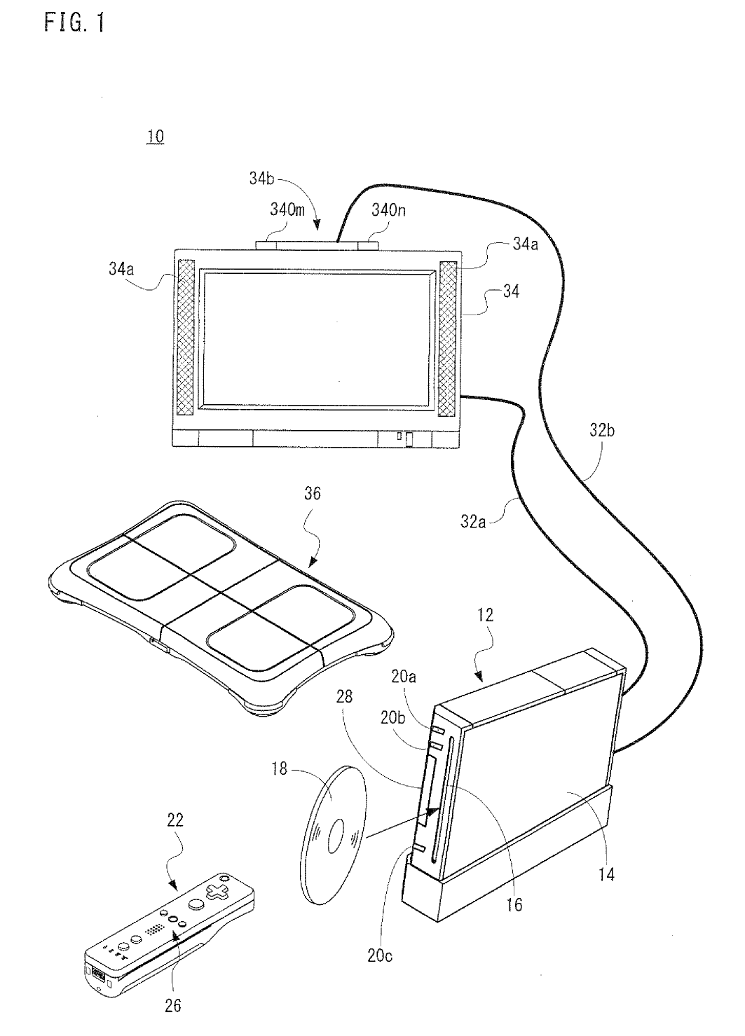

Referring to FIG. 1, a game system 10 of one embodiment of the present invention includes a video game apparatus (hereinafter, simply referred to as “game apparatus”) 12, a controller 22 and a load controller 36. Although illustration is omitted, the game apparatus 12 of this embodiment is designed such that it can be connected to four controllers (22, 36) at the maximum. Furthermore, the game apparatus 12 and the respective controllers (22, 36) are connected in a wireless manner. The wireless communication is executed according to a Bluetooth (registered trademark) standard, for example, but may be executed by other standards, such as infrared rays, a wireless LAN.

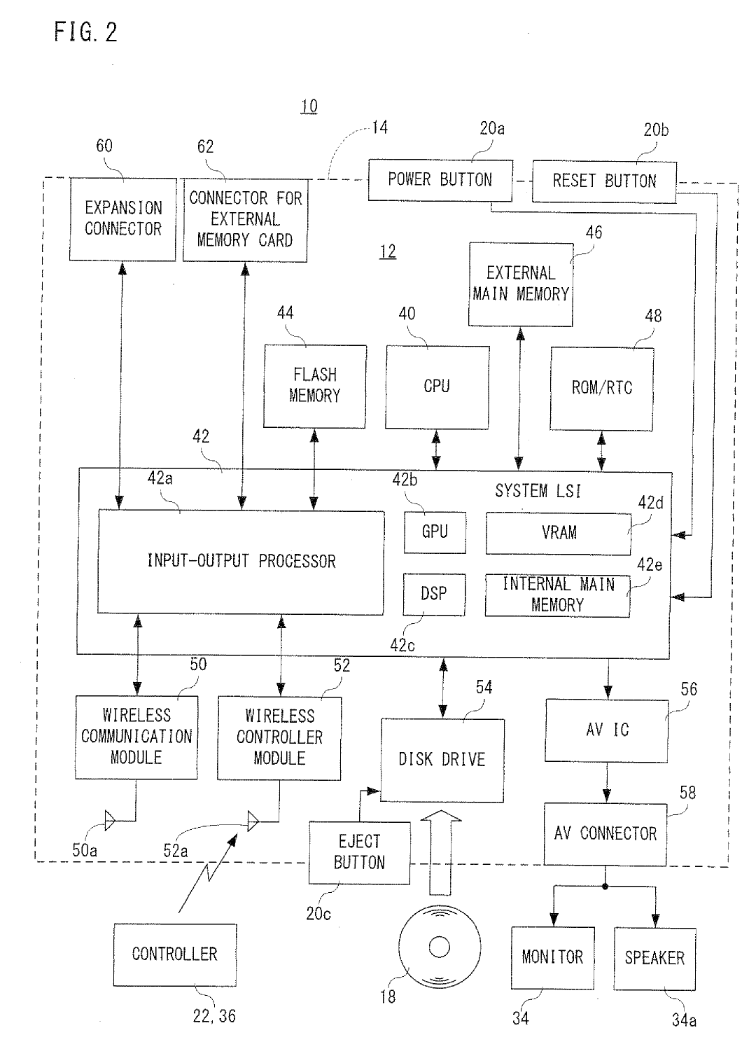

The game apparatus 12 includes a roughly rectangular parallelepiped housing 14, and the housing 14 is furnished with a disk slot 16 on a front surface. An optical disk 18 as one example of an information storage medium storing game program, etc. as one example of an information processing program is inserted from the disk slot 16 to be loaded into a disk drive 54 (see FIG. 2) within the housing 14. Around the disk slot 16, an LED and a light guide plate are arranged so as to be light on or off in accordance with various processing.

Furthermore, on a front surface of the housing 14 of the game apparatus 12, a power button 20a and a reset button 20b are provided at the upper part thereof, and an eject button 20c is provided below them. In addition, a connector cover for external memory card 28 is provided between the reset button 20b and the eject button 20c, and in the vicinity of the disk slot 16. Inside the connector cover for external memory card 28, an connector for memory card 62 (see FIG. 2) is provided, through which an external memory card (hereinafter simply referred to as a “memory card”) not shown is inserted. The memory card is employed for loading the game program, etc. read from the optical disk 18 to temporarily store it, storing (saving) game data (result data or proceeding data of the game) of the game played by means of the game system 10, and so forth. It should be noted that storing the game data described above may be performed on an internal memory, such as a flash memory 44 (see FIG. 2) inside the game apparatus 12 in place of the memory card. Also, the memory card may be utilized as a backup memory of the internal memory.

It should be noted that a general-purpose SD card can be employed as a memory card, but other general-purpose memory cards, such as MemoryStick, Multimedia Card (registered trademark) can be employed.

The game apparatus 12 has an AV cable connector 58 (see FIG. 2) on the rear surface of the housing 14, and by utilizing the AV cable connector 58, a monitor 34 and a speaker 34a are connected to the game apparatus 12 through an AV cable 32a. The monitor 34 and the speaker 34a are typically a color television receiver, and through the AV cable 32a, a video signal from the game apparatus 12 is input to a video input terminal of the color television, and a sound signal from the game apparatus 12 is input to a sound input terminal. Accordingly, a game image of a three-dimensional (3D) video game, for example, is displayed on the screen of the color television (monitor) 34, and stereo game sound, such as a game music, a sound effect, etc. is output from right and left speakers 34a. Around the monitor 34 (on the top side of the monitor 34, in this embodiment), a marker unit 34b including two infrared ray LEDs (markers) 340m and 340n is provided. The marker unit 34b is connected to the game apparatus 12 through a power source cable 32b. Accordingly, the marker unit 34b is supplied with power from the game apparatus 12. Thus, the markers 340m and 340n emit lights ahead of the monitor 34.

Furthermore, the power of the game apparatus 12 is applied by means of a general AC adapter (not illustrated). The AC adapter is inserted into a standard wall socket for home use, and the game apparatus 12 transforms the house current (commercial power supply) to a low DC voltage signal suitable for driving. In another embodiment, a battery may be utilized as a power supply.

In the game system 10, a user or a player turns the power of the game apparatus 12 on for playing the game (or applications other than the game). Then, the user selects an appropriate optical disk 18 storing a program of a video game (or other applications the player wants to play), and loads the optical disk 18 into the disk drive 54 of the game apparatus 12. In response thereto, the game apparatus 12 starts to execute a video game or other applications on the basis of the program recorded in the optical disk 18. The user operates the controller 22 in order to apply an input to the game apparatus 12. For example, by operating any one of the operating buttons of the input means 26, a game or other application is started. Besides the operation on the input means 26, by moving the controller 22 itself, it is possible to move a moving image object (player object) in different directions or change the perspective of the user (camera position) in a 3-dimensional game world.

FIG. 2 is a block diagram showing an electric configuration of the video game system 10 of FIG. 1 embodiment. Although illustration is omitted, respective components within the housing 14 are mounted on a printed board. As shown in FIG. 2, the game apparatus 12 has a CPU 40. The CPU 40 functions as a game processor. The CPU 40 is connected with a system LSI 42. The system LSI 42 is connected with an external main memory 46, a ROM/RTC 48, a disk drive 54, and an AV IC 56.

The external main memory 46 is utilized as a work area and a buffer area of the CPU 40 for storing programs like a game program, etc. and various data. The ROM/RTC 48, which is a so-called boot ROM, is incorporated with a program for activating the game apparatus 12, and is provided with a time circuit for counting a time. The disk drive 54 reads program data, texture data, etc. from the optical disk 18, and writes them in an internal main memory 42e described later or the external main memory 46 under the control of the CPU 40.

The system LSI 42 is provided with an input-output processor 42a, a GPU (Graphics Processor Unit) 42b, a DSP (Digital Signal Processor) 42c, a VRAM 42d and an internal main memory 42e, and these are connected with one another by internal buses although illustration is omitted.

The input-output processor (I/O processor) 42a executes transmitting and receiving data and executes downloading of the data. Reception and transmission and download of the data are explained in detail later.

The GPU 42b is made up of a part of a drawing means, and receives a graphics command (construction command) from the CPU 40 to generate game image data according to the command. Additionally, the CPU 40 applies an image generating program required for generating game image data to the GPU 42b in addition to the graphics command.

Although illustration is omitted, the GPU 42b is connected with the VRAM 42d as described above. The GPU 42b accesses the VRAM 42d to acquire data (image data: data such as polygon data, texture data, etc.) required to execute the construction command. Additionally, the CPU 40 writes image data required for drawing to the VRAM 42d via the GPU 42b. The GPU 42b accesses the VRAM 42d to create game image data for drawing.

In this embodiment, a case that the GPU 42b generates game image data is explained, but in a case of executing an arbitrary application except for the game application, the GPU 42b generates image data as to the arbitrary application.

Furthermore, the DSP 42c functions as an audio processor, and generates audio data corresponding to a sound, a voice, music, or the like to be output from the speaker 34a by means of the sound data and the sound wave (tone) data stored in the internal main memory 42e and the external main memory 46.

The game image data and audio data generated as described above are read by the AV IC 56, and output to the monitor 34 and the speaker 34a via the AV connector 58. Accordingly, a game screen is displayed on the monitor 34, and a sound (music) necessary for the game is output from the speaker 34a.

Furthermore, the input-output processor 42a is connected with a flash memory 44, a wireless communication module 50 and a wireless controller module 52, and is also connected with an expansion connector 60 and a connector for memory card 62. The wireless communication module 50 is connected with an antenna 50a, and the wireless controller module 52 is connected with an antenna 52a.

The input-output processor 42a can communicate with other game apparatuses and various servers to be connected to a network via a wireless communication module 50. It should be noted that it is possible to directly communicate with another game apparatus without going through the network. The input-output processor 42a periodically accesses the flash memory 44 to detect the presence or absence of data (referred to as data to be transmitted) being required to be transmitted to a network, and transmits it to the network via the wireless communication module 50 and the antenna 50a in a case that data to be transmitted is present. Furthermore, the input-output processor 42a receives data (referred to as received data) transmitted from another game apparatuses via the network, the antenna 50a and the wireless communication module 50, and stores the received data in the flash memory 44. If the received data does not satisfy a predetermined condition, the reception data is abandoned as it is. In addition, the input-output processor 42a can receive data (download data) downloaded from the download server via the network, the antenna 50a and the wireless communication module 50, and store the download data in the flash memory 44.

Furthermore, the input-output processor 42a receives input data transmitted from the controller 22 and the load controller 36 via the antenna 52a and the wireless controller module 52, and (temporarily) stores it in the buffer area of the internal main memory 42e or the external main memory 46. The input data is erased from the buffer area after being utilized in game processing by the CPU 40.

In this embodiment, as described above, the wireless controller module 52 makes communications with the controller 22 and the load controller 36 in accordance with Bluetooth standards.

Furthermore, for the sake of the drawings, FIG. 2 collectively shows the controller 22 and the load controller 36.

In addition, the input-output processor 42a is connected with the expansion connector 60 and the connector for memory card 62. The expansion connector 60 is a connector for interfaces, such as USB, SCSI, etc., and can be connected with medium such as an external storage, and peripheral devices such as another controller. Furthermore, the expansion connector 60 is connected with a cable LAN adaptor, and can utilize the cable LAN in place of the wireless communication module 50. The connector for memory card 62 can be connected with an external storage like a memory card. Thus, the input-output processor 42a, for example, accesses the external storage via the expansion connector 60 and the connector for memory card 62 to store and read the data.

Although a detailed description is omitted, as shown in FIG. 1, the game apparatus 12 (housing 14) is furnished with the power button 20a, the reset button 20b, and the eject button 20c. The power button 20a is connected to the system LSI 42. When the power button 20a is turned on, the system LSI 42 sets a mode of a normal energized state (referred to as “normal mode”) in which the respective components of the game apparatus 12 are supplied with power through an AC adapter not shown. On the other hand, when the power button 20a is turned off, the system LSI 42 sets a mode in which a part of the components of the game apparatus 12 is supplied with power, and the power consumption is reduced to minimum (hereinafter referred to as “standby mode”). In this embodiment, in a case that the standby mode is set, the system LSI 42 issues an instruction to stop supplying the power to the components except for the input-output processor 42a, the flash memory 44, the external main memory 46, the ROM/RTC 48 and the wireless communication module 50, and the wireless controller module 52. Accordingly, the standby mode is a mode in which the CPU 40 never executes an application.

Although the system LSI 42 is supplied with power even in the standby mode, supply of clocks to the GPU 42b, the DSP 42c and the VRAM 42d are stopped so as not to be driven, realizing reduction in power consumption.

Although illustration is omitted, inside the housing 14 of the game apparatus 12, a fan is provided for excluding heat of the IC, such as the CPU 40, the system LSI 42, etc. to outside. In the standby mode, the fan is also stopped.

However, in a case that the standby mode is not desired to be utilized, when the power button 20a is turned off, by making the standby mode unusable, the power supply to all the circuit components are completely stopped.

Furthermore, switching between the normal mode and the standby mode can be performed by turning on and off the power switch 26h of the controller 22 by remote control. If the remote control is not performed, setting is made such that the power supply to the wireless controller module 52 is not performed in the standby mode.

The reset button 20b is also connected with the system LSI 42. When the reset button 20b is pushed, the system LSI 42 restarts the activation program of the game apparatus 12. The eject button 20c is connected to the disk drive 54. When the eject button 20c is pushed, the optical disk 18 is ejected from the disk drive 54.

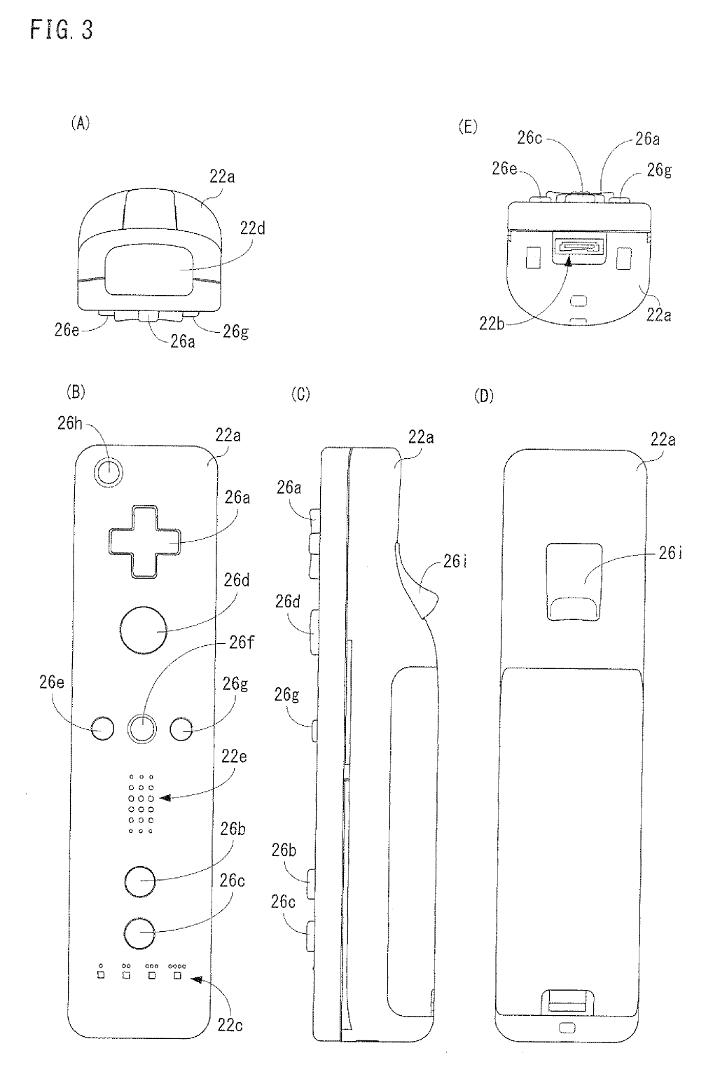

Each of FIG. 3 (A) to FIG. 3 (E) shows one example of an external appearance of the controller 22. FIG. 3 (A) shows a front end surface of the controller 22, FIG. 3 (B) shows a top surface of the controller 22, FIG. 3 (C) shows a right side surface of the controller 22, FIG. 3 (D) shows a lower surface of the controller 22, and FIG. 3 (E) shows a back end surface of the controller 22.

Referring to FIG. 3 (A) and FIG. 3 (E), the controller 22 has a housing 22a formed by plastic molding, for example. The housing 22a is formed into an approximately rectangular parallelepiped shape and has a size to be held by one hand of a user. The housing 22a (controller 22) is provided with the input means (a plurality of buttons or switches) 26. Specifically, as shown in FIG. 3 (B), on an upper face of the housing 22a, there are provided a cross key 26a, a 1 button 26b, a 2 button 26c, an A button 26d, a − button 26e, a HOME button 26f, a + button 26g and a power switch 26h. Moreover, as shown in FIG. 3 (C) and FIG. 3 (D), an inclined surface is formed on a lower surface of the housing 22a, and a B-trigger switch 26i is formed on the inclined surface.

The cross key 26a is a four directional push switch, including four directions of front (or upper), back (or lower), right and left operation parts. By operating any one of the operation parts, it is possible to instruct a moving direction of a character or object (player character or player object) that is be operable by a player or instruct the moving direction of a cursor.

The 1 button 26b and the 2 button 26c are respectively push button switches, and are used for a game operation, such as adjusting a viewpoint position and a viewpoint direction on displaying the 3D game image, i.e. a position and an image angle of a virtual camera. Alternatively, the 1 button 26b and the 2 button 26c can be used for the same operation as that of the A-button 26d and the B-trigger switch 26i or an auxiliary operation.

The A-button switch 26d is the push button switch, and is used for causing the player character or the player object to take an action other than that instructed by a directional instruction, specifically arbitrary actions such as hitting (punching), throwing, grasping (acquiring), riding, and jumping, etc. For example, in an action game, it is possible to give an instruction to jump, punch, move a weapon, and so forth. Also, in a roll playing game (RPG) and a simulation RPG, it is possible to give an instruction to acquire an item, select and determine the weapon and command, and so forth.

The − button 26e, the HOME button 26f, the + button 26g, and the power supply switch 26h are also push button switches. The − button 26e is used for selecting a game mode. The HOME button 26f is used for displaying a game menu (menu screen). The + button 26g is used for starting (re-starting) or pausing the game. The power supply switch 26h is used for turning on/off a power supply of the game apparatus 12 by remote control.

In this embodiment, note that the power supply switch for turning on/off the controller 22 itself is not provided, and the controller 22 is set at on-state by operating any one of the switches or buttons of the input means 26 of the controller 22, and when not operated for a certain period of time (30 seconds, for example) or more, the controller 22 is automatically set at off-state.

The B-trigger switch 26i is also the push button switch, and is mainly used for inputting a trigger such as shooting and designating a position selected by the controller 22. In a case that the B-trigger switch 26i is continued to be pushed, it is possible to make movements and parameters of the player object constant. In a fixed case, the B-trigger switch 26i functions in the same way as a normal B-button, and is used for canceling the action determined by the A-button 26d.

As shown in FIG. 3 (E), an external expansion connector 22b is provided on a back end surface of the housing 22a, and as shown in FIG. 3 (B), an indicator 22c is provided on the top surface of the side of the back end surface of the housing 22a. The external expansion connector 22b is utilized for connecting another expansion controller not shown. The indicator 22c is made up of four LEDs, for example, and shows identification information (controller number) of the controller 22 corresponding to the lighting LED by lighting any one of the four LEDs, and shows the remaining amount of power of the controller 22 depending on the number of LEDs to be emitted.

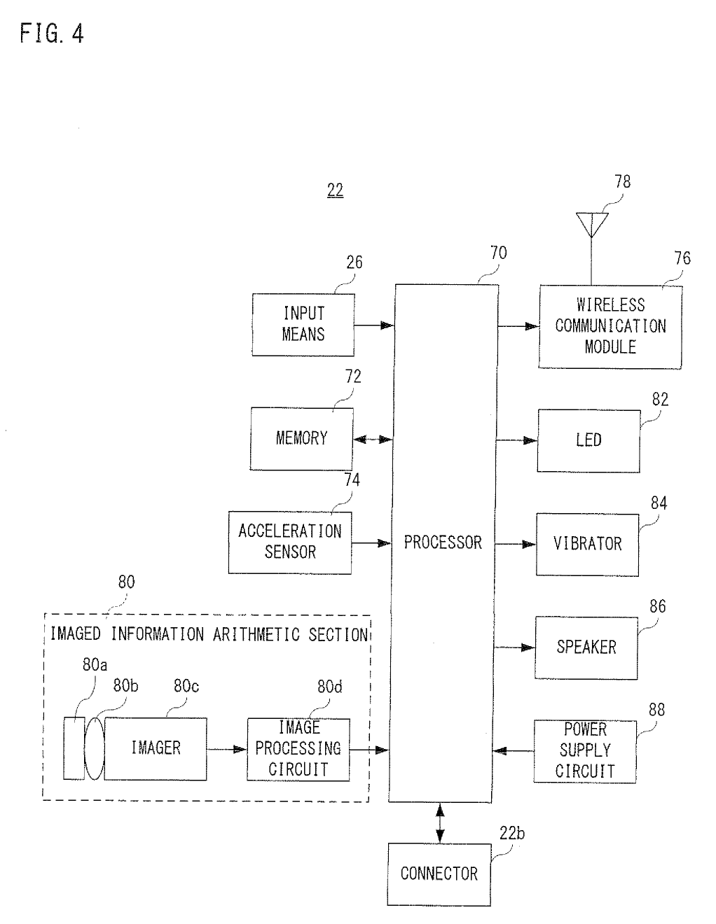

In addition, the controller 22 has an imaged information arithmetic section 80 (see FIG. 4), and as shown in FIG. 3 (A), on the front end surface of the housing 22a, a light incident opening 22d of the imaged information arithmetic section 80 is provided. Furthermore, the controller 22 has a speaker 86 (see FIG. 4), and the speaker 86 is provided inside the housing 22a at the position corresponding to a sound release hole 22e between the 1 button 26b and the HOME button 26f on the tope surface of the housing 22a as shown in FIG. 3 (B).

Note that, the shape of the controller 22 and the shape, number and setting position of each input means 26 shown in FIG. 3 (A) to FIG. 3 (E) are simple examples, and needless to say, even if they are suitably modified, the present invention can be realized.

FIG. 4 is a block diagram showing an electric configuration of the controller 22. Referring to FIG. 4, the controller 22 includes a processor 70, and the processor 70 is connected with the external expansion connector 22b, the input means 26, a memory 72, an acceleration sensor 74, a wireless communication module 76, the imaged information arithmetic section 80, an LED 82 (the indicator 22c), an vibrator 84, a speaker 86, and a power supply circuit 88 by an internal bus (not shown). Moreover, an antenna 78 is connected to the wireless communication module 76.

The processor 70 is in charge of an overall control of the controller 22, and transmits (inputs) information (input information) inputted by the input means 26, the acceleration sensor 74, and the imaged information arithmetic section 80 as input data, to the game apparatus 12 via the wireless communication module 76 and the antenna 78. At this time, the processor 70 uses the memory 72 as a working area or a buffer area.

An operation signal (operation data) from the aforementioned input means 26 (26a to 26i) is input to the processor 70, and the processor 70 stores the operation data once in the memory 72.

Moreover, the acceleration sensor 74 detects each acceleration of the controller 22 in directions of three axes of vertical direction (y-axial direction), lateral direction (x-axial direction), and forward and rearward directions (z-axial direction). The acceleration sensor 74 is typically an acceleration sensor of an electrostatic capacity type, but the acceleration sensor of other type may also be used.

For example, the acceleration sensor 74 detects the accelerations (ax, ay, and az) in each direction of x-axis, y-axis, z-axis for each first predetermined time, and inputs the data of the acceleration (acceleration data) thus detected to the processor 70. For example, the acceleration sensor 74 detects the acceleration in each direction of the axes in a range from −2.0 g to 2.0 g (g indicates a gravitational acceleration. The same thing can be said hereafter.) The processor 70 detects the acceleration data given from the acceleration sensor 74 for each second predetermined time, and stores it in the memory 72 once. The processor 70 creates input data including at least one of the operation data, acceleration data and marker coordinate data as described later, and transmits the input data thus created to the game apparatus 12 for each third predetermined time (5 msec, for example).

In this embodiment, although omitted in FIG. 3 (A) to FIG. 3 (E), the acceleration sensor 74 is provided inside the housing 22a and in the vicinity on the circuit board where the cross key 26a is arranged.

The wireless communication module 76 modulates a carrier of a predetermined frequency by the input data, by using a technique of Bluetooth, for example, and emits its weak radio wave signal from the antenna 78. Namely, the input data is modulated to the weak radio wave signal by the wireless communication module 76 and transmitted from the antenna 78 (controller 22). The weak radio wave signal is received by the radio controller module 52 provided to the aforementioned game apparatus 12. The weak radio wave thus received is subjected to demodulating and decoding processing. This makes it possible for the game apparatus 12 (CPU 40) to acquire the input data from the controller 22. Then, the CPU 40 performs game processing, following the input data and the program (game program).

In addition, as described above, the controller 22 is provided with the imaged information arithmetic section 80. The imaged information arithmetic section 80 is made up of an infrared rays filter 80a, a lens 80b, an imager 80c, and an image processing circuit 80d. The infrared rays filter 80a passes only infrared rays from the light incident from the front of the controller 22. As described above, the markers 340m and 340n placed near (around) the display screen of the monitor 34 are infrared LEDs for outputting infrared lights ahead of the monitor 34. Accordingly, by providing the infrared rays filter 80a, it is possible to image the image of the markers 340m and 340n more accurately. The lens 80b condenses the infrared rays passing thorough the infrared rays filter 80a to emit them to the imager 80c. The imager 80c is a solid imager, such as a CMOS sensor and a CCD, for example, and images the infrared rays condensed by the lens 80b. Accordingly, the imager 80c images only the infrared rays passing through the infrared rays filter 80a to generate image data. Hereafter, the image imaged by the imager 80c is called an “imaged image”. The image data generated by the imager 80c is processed by the image processing circuit 80d. The image processing circuit 80d calculates a position of an object to be imaged (markers 340m and 340n) within the imaged image, and outputs each coordinate value indicative of the position to the processor 70 as imaged data for each fourth predetermined time. It should be noted that a description of the process in the image processing circuit 80d is made later.

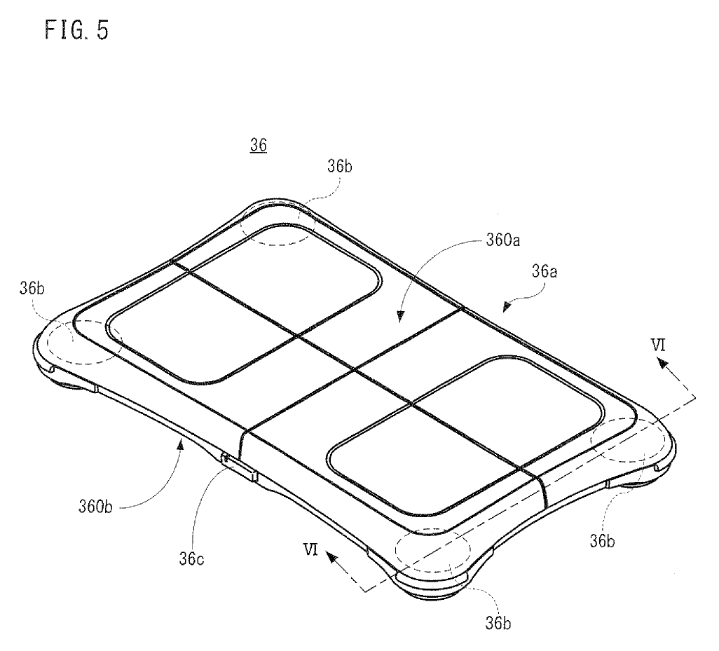

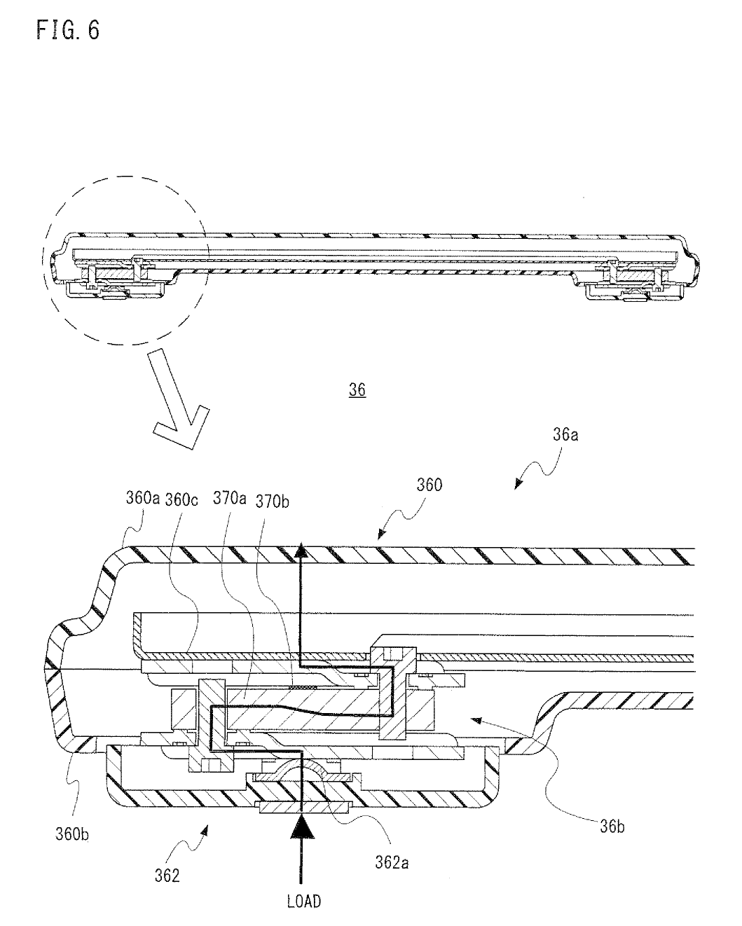

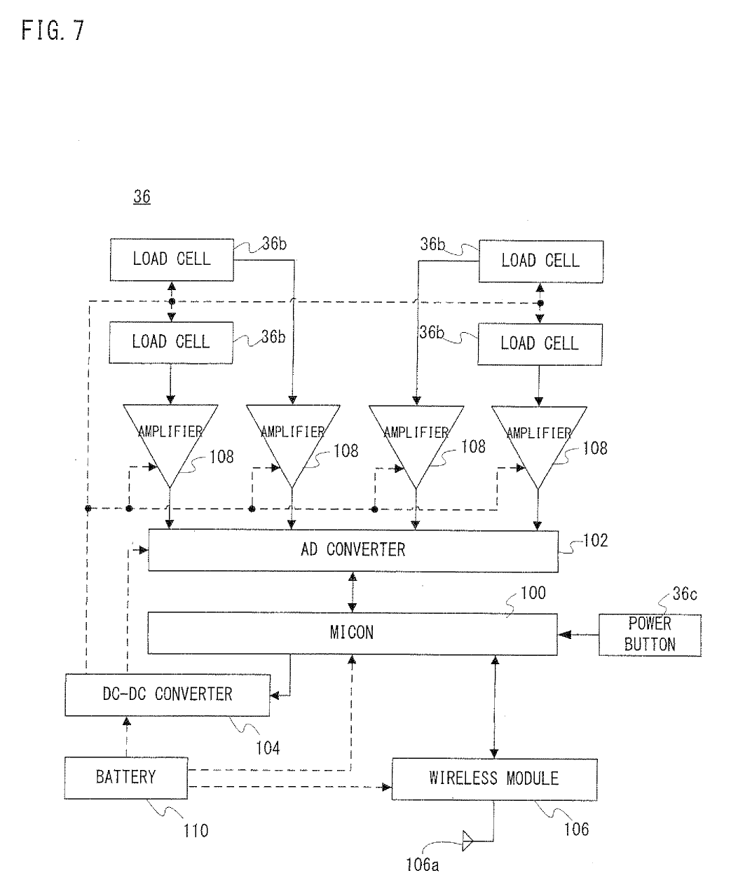

FIG. 5 is a perspective view showing an appearance of the load controller 36 shown in FIG. 1. As shown in FIG. 5, the load controller 36 includes a board 36a on which a player rides (a player puts his or her foot) and at least four load sensors 36b that detect loads imposed on the board 36a. The load sensors 36b are accommodated in the board 36a (see FIG. 6 and FIG. 7), and the arrangement of the load sensors 36b is shown by dotted line in FIG. 5.

The board 36a is formed in a substantially rectangle, and the board 36a has a substantially rectangular shape when viewed from above. For example, a short side of the rectangular is set in the order of 30 cm, and a long side thereof is set in the order of 50 cm. An upper surface of the board 36a on which the player rides is formed in flat. Side faces at four corners of the board 36a are formed so as to be partially projected in a cylindrical shape.

In the board 36a, the four load sensors 36b are arranged at predetermined intervals. In the embodiment, the four load sensors 36b are arranged in peripheral portions of the board 36a, specifically, at the four corners. The interval between the load sensors 36b is set an appropriate value such that player's intention can accurately be detected for the load applied to the board 36a in a game manipulation.

FIG. 6 shows a sectional view taken along the line VI-VI of the load controller 36 shown in FIG. 5, and also shows an enlarged corner portion disposed in the load sensor 36b. As can be seen from FIG. 6, the board 36a includes a support plate 360 on which the player rides and legs 362. The legs 362 are provided at positions where the load sensors 36b are arranged. In the embodiment, because the four load sensors 36b are arranged at four corners, the four legs 362 are provided at the four corners. The leg 362 is formed in a cylindrical shape with bottom by, e.g., plastic molding. The load sensor 36b is placed on a spherical part 362a provided in the bottom of the leg 362. The support plate 360 is supported by the leg 362 while the load sensor 36b is interposed.

The support plate 360 includes an upper-layer plate 360a that constitutes an upper surface and an upper side face, a lower-layer plate 360b that constitutes a lower surface and a lower side face, and an intermediate-layer plate 360c provided between the upper-layer plate 360a and the lower-layer plate 360b. For example, the upper-layer plate 360a and the lower-layer plate 360b are formed by plastic molding and integrated with each other by bonding. For example, the intermediate-layer plate 360c is formed by pressing one metal plate. The intermediate-layer plate 360c is fixed onto the four load sensors 36b. The upper-layer plate 360a has a lattice-shaped rib (not shown) in a lower surface thereof, and the upper-layer plate 360a is supported by the intermediate-layer plate 360c while the rib is interposed.

Accordingly, when the player rides on the board 36a, the load is transmitted to the support plate 360, the load sensor 36b, and the leg 362. As shown by an arrow in FIG. 6, reaction generated from a floor by the input load is transmitted from the legs 362 to the upper-layer plate 360a through the spherical part 362a, the load sensor 36b, and the intermediate-layer plate 360c.

The load sensor 36b is formed by, e.g., a strain gage (strain sensor) type load cell, and the load sensor 36b is a load transducer that converts the input load into an electric signal. In the load sensor 36b, a strain inducing element 370a is deformed to generate a strain according to the input load. The strain is converted into a change in electric resistance by a strain sensor 370b adhering to the strain inducing element 370a, and the change in electric resistance is converted into a change in voltage. Accordingly, the load sensor 36b outputs a voltage signal indicating the input load from an output terminal.

Other types of load sensors such as a folk vibrating type, a string vibrating type, an electrostatic capacity type, a piezoelectric type, a magneto-striction type, and gyroscope type may be used as the load sensor 36b.

Returning to FIG. 5, the load controller 36 is further provided with a power button 36c. When the power button 36c is turned on, power is supplied to the respective circuit components (see FIG. 7) of the load controller 36. It should be noted that the load controller 36 may be turned on in accordance with an instruction from the game apparatus 12. Furthermore, the power of the load controller 36 is turned off when a state that the player does not ride continues for a given time of period (30 seconds, for example). Alternatively, the power may be turned off when the power button 36c is turned on in a state that the load controller 36 is activated.

FIG. 7 is a block diagram showing an example of an electric configuration of the load controller 36. In FIG. 7, the signal and communication stream are indicated by solid-line arrows, and electric power supply is indicated by broken-line arrows.

The load controller 36 includes a microcomputer 100 that controls an operation of the load controller 36. The microcomputer 100 includes a CPU, a ROM and a RAM (not shown), and the CPU controls the operation of the load controller 36 according to a program stored in the ROM.

The microcomputer 100 is connected with the power button 36c, the A/D converter 102, a DC-DC converter 104 and a wireless module 106. In addition, the wireless module 106 is connected with an antenna 106a. Furthermore, the four load sensors 36b are displayed as a load cell 36b in FIG. 3. Each of the four load sensors 36b is connected to the A/D converter 102 via an amplifier 108.

Furthermore, the load controller 36 is provided with a battery 110 for power supply. In another embodiment, an AC adapter in place of the battery is connected to supply a commercial power supply. In such a case, a power supply circuit has to be provided for converting alternating current into direct current and stepping down and rectifying the direct voltage in place of the DC-DC converter. In this embodiment, the power supply to the microcomputer 100 and the wireless module 106 are directly made from the battery. That is, power is constantly supplied to a part of the component (CPU) inside the microcomputer 100 and the wireless module 106 to thereby detect whether or not the power button 36c is turned on, and whether or not a power-on (load detection) command is transmitted from the game apparatus 12. On the other hand, power from the battery 110 is supplied to the load sensor 36b, the A/D converter 102 and the amplifier 108 via the DC-DC converter 104. The DC-DC converter 104 converts the voltage level of the direct current from the battery 110 into a different voltage level, and applies it to the load sensor 36b, the A/D converter 102 and the amplifier 108.

The electric power may be supplied to the load sensor 36b, the A/D converter 102, and the amplifier 108 if needed such that the microcomputer 100 controls the DC-DC converter 104. That is, when the microcomputer 100 determines that a need to operate the load sensor 36b to detect the load arises, the microcomputer 100 may control the DC-DC converter 104 to supply the electric power to each load sensor 36b, the A/D converter 102, and each amplifier 108.

Once the electric power is supplied, each load sensor 36b outputs a signal indicating the input load. The signal is amplified by each amplifier 108, and the analog signal is converted into digital data by the A/D converter 102. Then, the digital data is input to the microcomputer 100. Identification information on each load sensor 36b is imparted to the detection value of each load sensor 36b, allowing for distinction among the detection values of the load sensors 36b. Thus, the microcomputer 100 can obtain the pieces of data (load data) indicating the detection values of the four load sensors 36b at the same hour.

On the other hand, when the microcomputer 100 determines that the need to operate the load sensor 36b does not arise, i.e., when the microcomputer 100 determines it is not the time the load is detected, the microcomputer 100 controls the DC-DC converter 104 to stop the supply of the electric power to the load sensor 36b, the A/D converter 102 and the amplifier 108. Thus, in the load controller 36, the load sensor 36b is operated to detect the load only when needed, so that the power consumption for detecting the load can be suppressed.

Typically, the time the load detection is required shall means the time the game apparatus 12 (FIG. 1) obtains the load data. For example, when the game apparatus 12 requires the load information, the game apparatus 12 transmits a load obtaining command to the load controller 36. When the microcomputer 100 receives the load obtaining command from the game apparatus 12, the microcomputer 100 controls the DC-DC converter 104 to supply the electric power to the load sensor 36b, etc., thereby detecting the load. On the other hand, when the microcomputer 100 does not receive the load obtaining command from the game apparatus 12, the microcomputer 100 controls the DC-DC converter 104 to stop the electric power supply. Alternatively, the microcomputer 100 determines it is the time the load is detected at regular time intervals, and the microcomputer 100 may control the DC-DC converter 104. In the case when the microcomputer 100 periodically obtains the load, information on the period may initially be imparted from the game machine 12 to the microcomputer 100 or previously stored in the microcomputer 100.

The data, that is, load data indicating the four detection values from the four load sensors 36b are transmitted as the input data of the load controller 36 from the microcomputer 100 to the game apparatus 12 (FIG. 1) through the wireless module 106 and the antenna 106a. For example, in the case where the command is received from the game apparatus 12 to detect the load, the microcomputer 100 transmits the detection value data to the game apparatus 12 when receiving the load detected value data of the load sensor 36b from the A/D converter 102. Alternatively, the microcomputer 100 may transmit the load detected value data to the game apparatus 12 at regular time intervals.

Additionally, the wireless module 106 can communicate by a radio standard (Bluetooth, wireless LAN, etc.) the same as that of the radio controller module 52 of the game apparatus 12. Accordingly, the CPU 40 of the game apparatus 12 can transmit a load obtaining command to the load controller 36 via the radio controller module 52, etc. The microcomputer 100 of the load controller 36 can receive a command from the game apparatus 12 via the wireless module 106 and the antenna 106a, and transmit load data including load detecting values (or load calculating values) of the respective load sensors 36b to the game apparatus 12.

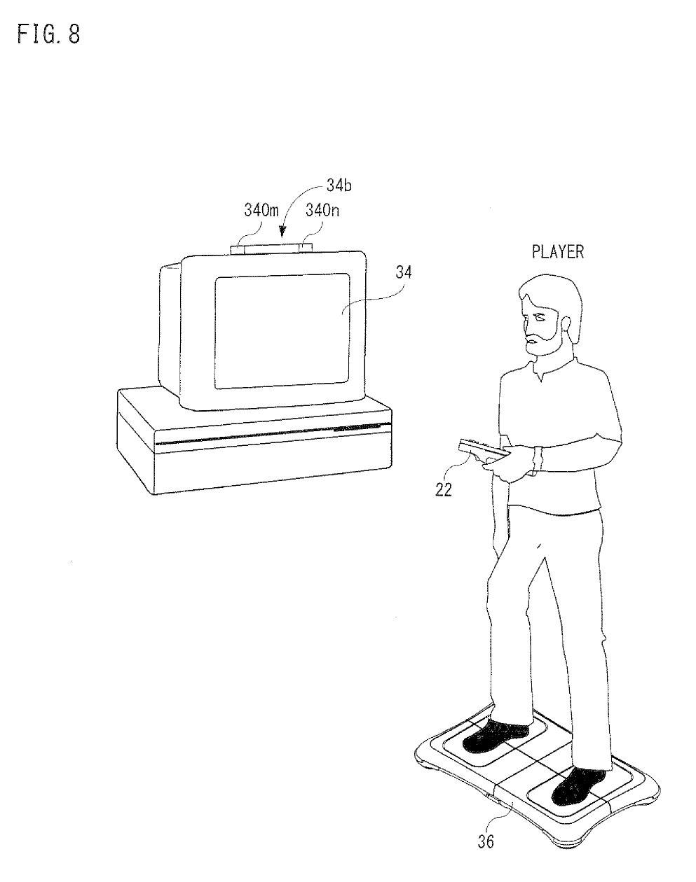

FIG. 8 is an illustrative view roughly explaining a state in which the virtual game, such as “balance testing game” (described later) is played using the controller 22 and load controller 36. As shown in FIG. 8, when playing the virtual game by utilizing the controller 22 and the load controller 36 in the video game system 10, the player grasps the controller 22 in one hand while riding on the load controller 36. Exactly, the player grasps the controller 22 with the front-end surface (the side of the incident port 22d to which the light imaged by the imaged information arithmetic section 80 is incident) of the controller 22 orientated toward the markers 340m and 340n while riding on the load controller 36. However, as can be seen from FIG. 1, the markers 340m and 340n are disposed in parallel with the crosswise direction of the screen of the monitor 34. In this state of things, the player changes the position on the screen indicated by the controller 22 or the distance between the controller 22 and the marker 340m or 340n to perform the game manipulation.

It should be noted that in FIG. 8, the load controller 36 is vertically placed such that the player turns sideways with respect to the screen of the monitor 34, but depending on the game, the load controller 36 may be horizontally placed such that the player turns front with respect to the screen of the monitor 34.

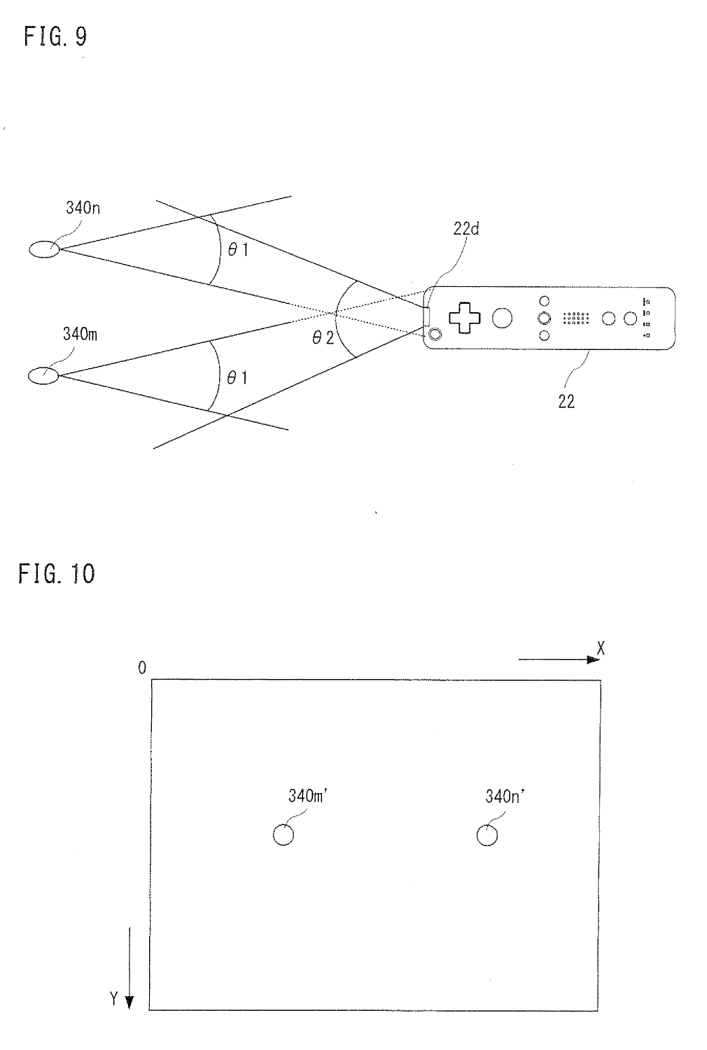

FIG. 9 is an illustrative view for explaining view angles of the markers 340m and 340n and controller 22. As shown in FIG. 9, the markers 340m and 340n each emit the infrared ray in a range of a view angle θ1. The imager 80c of the imaged information arithmetic section 80 can receive the incident light in a range of a view angle θ2 around a visual axis direction of the controller 22. For example, each of the markers 340m and 340n has the view angle θ1 of 34° (half-value angle), and the imager 80c has the view angle θ2 of 41°. The player grasps the controller 22 such that the imager 80c is set to the position and orientation at which the infrared rays can be received from the two markers 340m and 340n. Specifically, the player grasps the controller 22 such that at least one of the markers 340m and 340n exists in the view angle θ2 of the imager 80c while the controller 22 exists in the view angle θ1 of at least one of the markers 340m and 340n. In this state, the controller 22 can detect at least one of the markers 340m and 340n. The player can change the position and orientation of the controller 22 to perform the game manipulation in the range satisfying this state.

In the case where the position and orientation of the controller 22 are out of the range, the game manipulation cannot be performed based on the position and orientation of the controller 22. Hereinafter the range is referred to as “manipulable range”.

In the case where the controller 22 is grasped in the manipulable range, the images of the markers 340m and 340n are taken by the imaged information arithmetic section 80. That is, the imaged image obtained by the imager 80c includes the images (target images) of the markers 340m and 340n that are of the imaging target. FIG. 10 is a view showing an example of the imaged image including the target image. Using the image data of the imaged image including the target image, the image processing circuit 80d computes the coordinate (marker coordinate) indicating the position in the imaged images of the markers 340m and 340n.

Because the target image appears as a high-brightness portion in the image data of the imaged image, the image processing circuit 80d detects the high-brightness portion as a candidate of the target image. Then, the image processing circuit 80d determines whether or not the high-brightness portion is the target image based on the size of the detected high-brightness portion. Sometimes the imaged image includes not only images 340m′ and 340n′ corresponding to the two markers 340m and 340n that are of the target image but also the image except for the target image due to the sunlight from a window or a fluorescent light. The processing of the determination whether or not the high-brightness portion is the target image is performed in order to distinguish the images 340m′ and 340n′ of the makers 340m and 340n that are of the target image from other images to exactly detect the target image. Specifically, the determination whether or not the detected high-brightness portion has the size within a predetermined range is made in the determination processing. When the high-brightness portion has the size within the predetermined range, it is determined that the high-brightness portion indicates the target image. On the contrary, when the high-brightness portion does not have the size within the predetermined range, it is determined that the high-brightness portion indicates the image except for the target image.

Then, the image processing circuit 80d computes the position of the high-brightness portion for the high-brightness portion in which it is determined indicate the target image as a result of the determination processing. Specifically, a barycentric position of the high-brightness portion is computed. Hereinafter, the coordinate of the barycetric position is referred to as marker coordinate. The barycetnric position can be computed in more detail compared with resolution of the imager 80c. At this point, it is assumed that the image taken by the imager 80c has the resolution of 126×96 and the barycetnric position is computed in a scale of 1024×768. That is, the marker coordinate is expressed by an integer number of (0,0) to (1024, 768).

The position in the imaged image is expressed by a coordinate system (XY-coordinate system) in which an origin is set to an upper left of the imaged image, a downward direction is set to a positive Y-axis direction, and a rightward direction is set to a positive X-axis direction.

In the case where the target image is correctly detected, two marker coordinates are computed because the two high-brightness portions are determined as the target image by the determination processing. The image processing circuit 80d outputs the pieces of data indicating the two computed marker coordinates. As described above, the output pieces of marker coordinate data are added to the input data by the processor 70 and transmitted to the game apparatus 12.

When the game apparatus 12 (CPU 40) detects the marker coordinate data from the received input data, the game apparatus 12 can compute the position (coordinate position) indicated by the controller 22 on the screen of the monitor 34 and the distances between the controller 22 and the markers 340m and 340n based on the marker coordinate data. Specifically, the position toward which the controller 22 is orientated, i.e., the indicated position is computed from the position at the midpoint of the two marker coordinates. The distance between the target images in the imaged image is changed according to the distances between the controller 22 and the markers 340m and 340n, and therefore, by computing the distance between the marker coordinates, the game apparatus 12 can compute the current distances between the controller 22 and the markers 340m and 340n.

In a case that a “balance testing game” is played in the game system 10 configured as described above, the game apparatus 12 (CPU 40) executes game processing described later on the basis of the operation data and the marker coordinate data out of the operation data, the acceleration data and the marker coordinate data included in the input data from the controller 22 and the input data from the load controller 36, that is, the load data. The acceleration data is not especially utilized in the “balance testing game”.

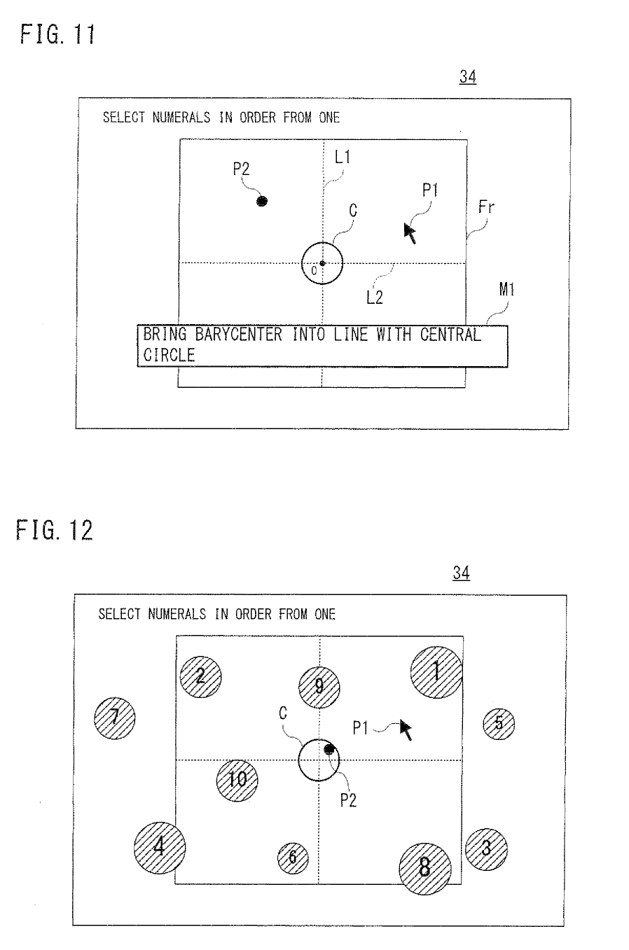

First, the outline of the “balance testing game” is explained. A series of game screens from the start of the “balance testing game” to the end of it are shown in FIG. 11-FIG. 16. When the game is started, the game screen shown in FIG. 11 is first displayed. The game screen includes a rectangular frame Fr indicating a play area arranged at the center of the screen, crossing lines L1 and L2 for dividing the frame Fr into four, and a circle C (hereinafter referred to as “central circle C”) arranged at the center of the frame Fr (approximately the center of the screen) and having a diameter in the order of a small fraction of the one side of the frame Fr. The intersection point of the crossing lines L1 and L2 indicates a center point of the rectangle Fr, moreover the center of the screen, and is called as a “center point O”. The center point O is coincident with the center point of the central circle C. Here, the central circle C may be approximately the center of the screen, and may be at a position far from the center point O under certain circumstances.

Then, a coordinate position pointer P1 based on the marker coordinate data and a barycentric position pointer P2 based on the load data are drawn on the game screen. At first, the barycentric position pointer P2 is positioned outside the central circle C, and a message M1 requesting the user to move the barycentric position pointer P2 into the central circle C, such as “bring the barycenter into line with the central circle”, for example, is displayed.

When the player guides the barycentric position pointer P2 into the central circle C by operating the load controller 36 (by moving the body weight), the message M1 is erased, and 10 buttons (hereinafter referred to as “numerals 1-10”) each indicating numerals 1-10 are displayed by color as shown in FIG. 12. The numerals 1-10 are dispersively arranged outside the central circle C, and each has any one of large, medium and small sizes. Here, each of the numerals 2, 3, 7, 9 and 10 of the medium size has a size substantially the same as that of the central circle C, each of the numerals 5 and 6 of the small size is smaller than the central circle C, and each of the numerals 1, 4 and 8 of the large size is larger than the central circle C. Noted that the number of numerals is not restricted to 10, and this may be 1-9 or 11 or more. The size of the numerals is not restricted to three kinds, and this may be one kind, two kinds or four kinds or more.

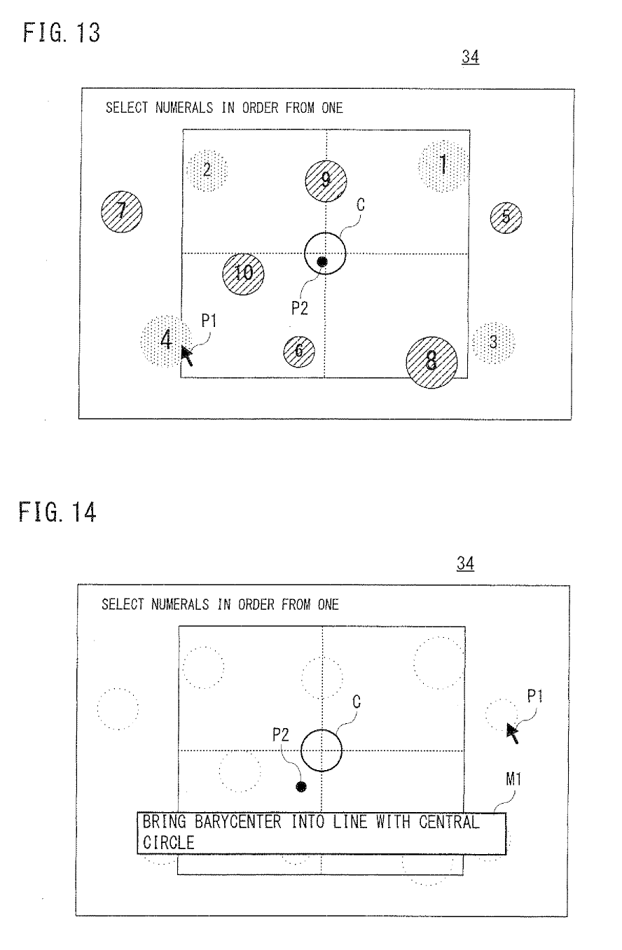

When the numerals 1-10 are thus displayed, time keeping starts, and the player successively selects the numerals 1-10 with the controller 22. The selection is performed by pushing the A button 26d with the coordinate position pointer P1 put on the desired numeral (4 here) as shown in FIG. 13. If the selected numeral is correct (the smallest numeral out of the unselected numerals), the color of the numeral changes from color to gray. If the selected numeral is mistaken numeral (if the selected numeral is the numeral which has already selected numeral or if the selected numeral is the unselected, but not the smallest numeral), such change does not occur.

On the game screen shown in FIG. 13, the numerals 1-4 have already selected, and the numeral 5 is a next object to be selected. Thereupon, the player moves the coordinate position pointer P1 from the numeral 4 to the numeral 5 by operating the controller 22, and performs a selection on the A button 26d. By performing such an operation, the barycenter of the body of the player is unconsciously moved, so that the barycentric position pointer P2 may extend from the central circle C.

When the barycentric position pointer P2 extends off the central circle C, the message M1 is displayed again as shown in FIG. 14, and the numerals 1-10 are erased. When the player guides the barycentric position pointer P2 into the central circle C by operating the load controller 36 again, the game screen returns to the state shown in FIG. 13. However, as a result of such an operating the load controller 36, the coordinate position pointer P1 is off the numeral 5, and a further operation of the controller 22 may be required in order to modify this. Accordingly, the player is required to simultaneously operate the controller 22 and the load controller 36 depending on the two pointers P1 and P2 on the screen.

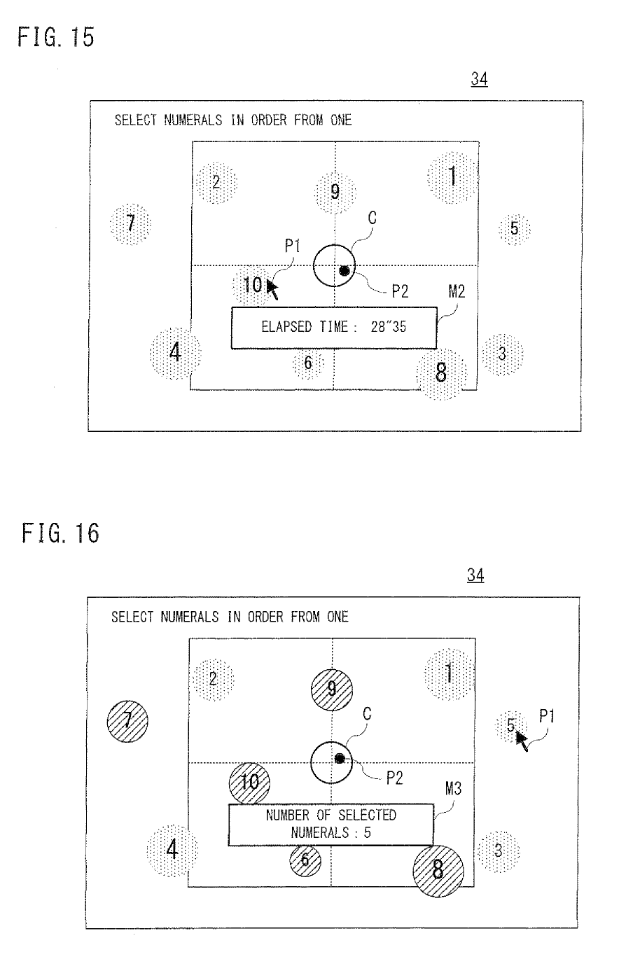

When the player finishes selecting all the numerals 1-10, the game is to be cleared, and as shown in FIG. 15, a message M2 indicating time keeping at this time point, that is, an elapsed time (“28 seconds 35” for example) is displayed. On the other hand, when the result of the time keeping goes through a preset value, 30 seconds, for example before end of the selection, time out occurs, and a message M3 indicating the number of selected numeral (“5”, for example) at this point is displayed as shown in FIG. 16.

Accordingly, in a case that the “balance testing game” is played by a plurality of players, the player who takes less time to attain the game clear is ranked higher, and the player who is subjected to time out is ranked lower than the player who is ranked the lowest out of the players who clear the game. Out of the players who are subjected to time out, the more the player has the selected numeral, the higher the player is ranked.

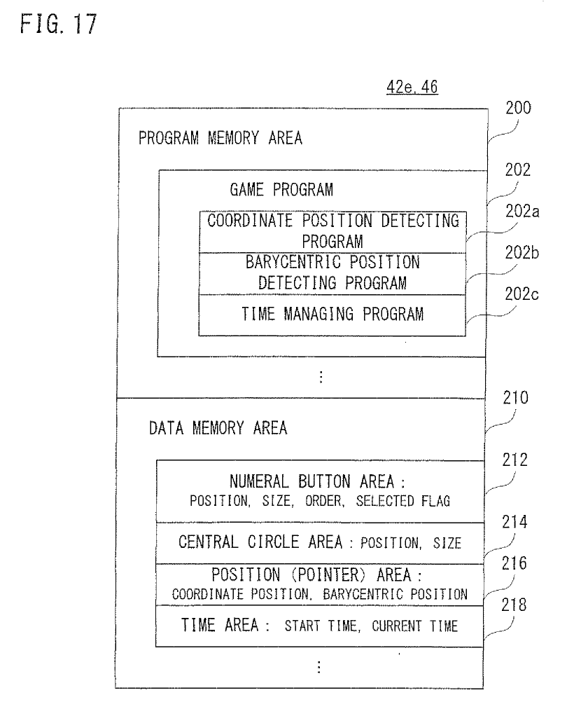

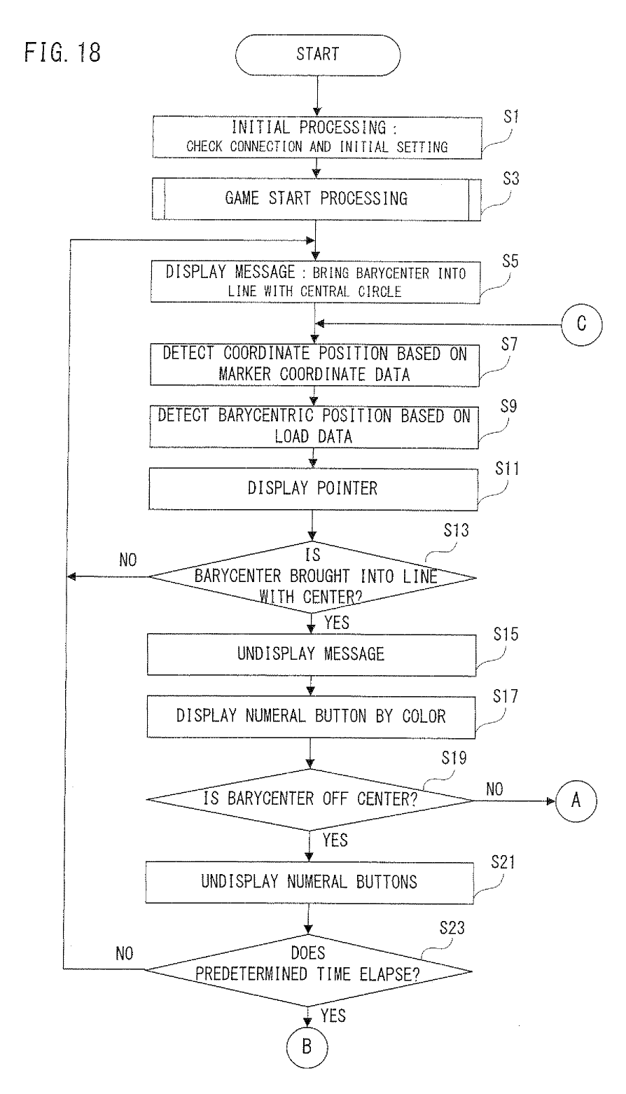

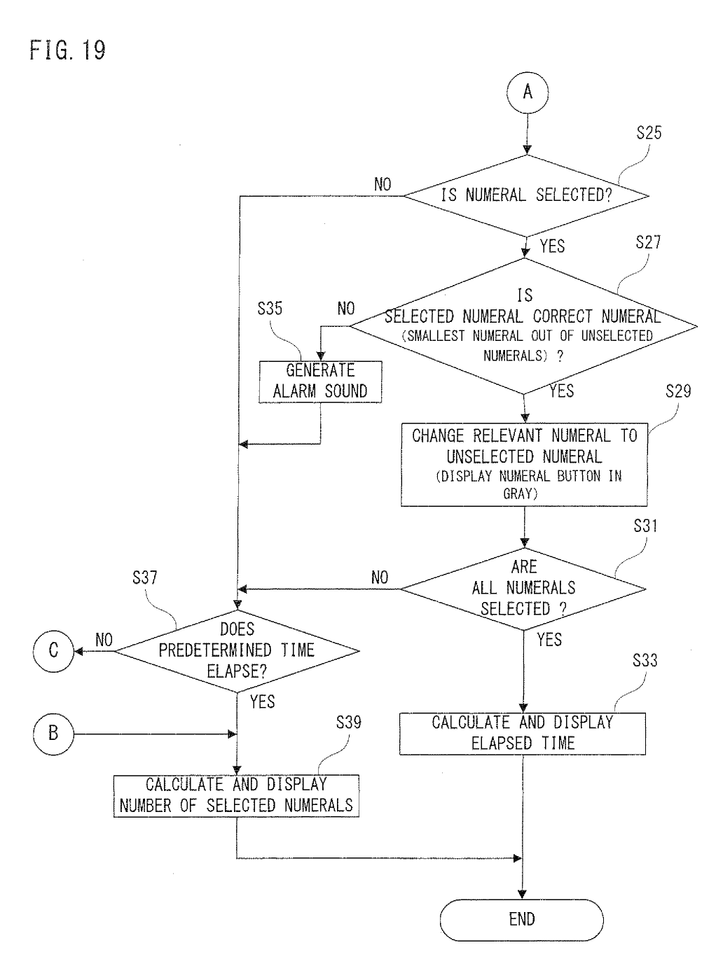

Next, a concrete example in order to implement such the “balance testing game”, that is, an operation of the CPU 40 is explained with reference to a memory map shown in FIG. 17 and a flowchart shown in FIG. 18-FIG. 20. In the internal main memory 42e or the external main memory 46, a program memory area 200 and a data memory area 210 are formed as shown in FIG. 17. In the program memory area 200, the game program 202 corresponding to the flowcharts shown in. FIG. 18-FIG. 20 is stored. The game program 202 includes a coordinate position detecting program 202a, a barycentric position detecting program 202b, and a time managing program 202c. The data memory area 210 includes a numeral button area 212, a central circle area 214, a position (pointer) area 216, and a time area 218.

The game program 200 is a main program to implement the “balance testing game”. The coordinate position detecting program 202a is a subprogram utilized by the main program, and detects a coordinate position (designation position) within the game screen on the basis of the marker coordinate data from the controller 22. The barycentric position detecting program 202b is a subprogram to be utilized by the main program, and detects a barycentric position of the user on the basis of the load data from the load controller 36. The time managing program 202c is a subprogram to be utilized by the main program, and keeps a time based on the time information from the ROM/RTC 48 to calculate an elapsed time and detect time out on the basis of the result of the time keeping.

The numeral button area 212 is an area for storing a position, a size, an order and a selected flag with respect to each of the numerals buttons 1-10. The selected flag is turned off at an initial condition, and turned on according to a selecting operation by the player. The central circle area 214 is an area for storing a position and a size with respect to the central circle C. The position (pointer) area 216 is an area for storing a coordinate position (position of the pointer P1) detected by the coordinate position detecting program 202a and a barycentric position (position of the pointer P2) detected by the barycentric position detecting program 202b. The time area 218 is an area for storing time information, such as a start time, a current time, etc., required to calculate an elapsed time and detect time out by the time managing program 202c.

The CPU 40 executes the game processing shown in the flowchart in FIG. 18-FIG. 20 on the basis of the program and data shown in FIG. 17. When activating the “balance testing game”, the CPU 40 executes initial processing in a step S1. The initial processing includes processing of checking a connection between the game apparatus 12 and the load controller 36, and processing of setting an initial value (zero value, that is, a load value when the player does not ride, a body weight value of the player, etc.) to the load controller 36. After completion of the initial processing, the process proceeds to a step S3 to execute game start processing.

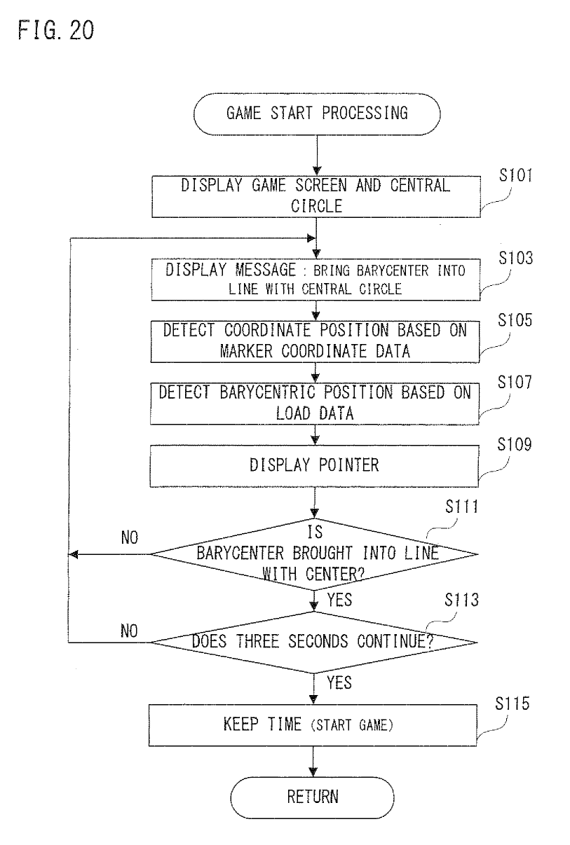

The game start processing in a step S3 is executed according to a subroutine shown in FIG. 20. In a step S101, a game screen arranged with the central circle C at approximately the center is displayed on the monitor 34, and in a step S103, the message M1, that is, “bring the barycenter into line with the central circle” is displayed.

In a step S105, a coordinate position is detected on the basis of the marker coordinate data from the load controller 22, and in a step S107, a barycentric position is detected on the basis of the load data from the load controller 22. These two detection results are stored in the position area 216, and in a next step S109, the coordinate position pointer P1 and the barycentric position pointer P2 are displayed on the basis of the information on the position area 216 (coordinate position and barycentric position). The game screen is as shown in FIG. 11 at this time point.

In a step S111, it is determined whether or not the barycenter is brought into line with the center on the basis of the information of the central circle area 214 (position and size) and the information of the position area 216 (barycentric position). If the barycentric position is off the central circle C, “NO” is determined in the step S111, and the process returns to the step S103. If the barycentric position is within the central circle C or on the circumference, “YES” is determined in the step S111, and the process proceeds to a step S113. In the step S113, a duration during which the determination result in the step S111 is “YES” is counted, and it is determined whether or not the result of the counting runs beyond a predetermined time (3 seconds, for example). If “NO” in the step S113, the process returns to the step S103, and if “YES”, the process proceeds to a step S115 to start time keeping. The game is started at this time point (start time), and the process returns to the hierarchical upper level of the routine.

In a step S5, the message M1, that is, “bring the barycenter into line with the central circle” is displayed. In a step S7, a coordinate position is detected on the basis of the marker coordinate data from the controller 22, and in a step S9, a barycentric position is detected on the basis of the load data from the load controller 22. These two detection results are stored in the position area 216, and in a next step S11, the coordinate position pointer P1 and the barycentric position pointer P2 are displayed on the basis of the information of the position area 216 (coordinate position and barycentric position). The game screen is as shown in FIG. 11 at this time point.

In a step S13, it is determined whether or not the barycenter is brought into line with the center on the basis of the information of the central circle area 214 (position and size) and the information of the position area 216 (barycentric position). If the barycentric position is outside the central circle C, “NO” is determined in the step S13, and the process returns to the step S5. If the barycentric position is within the central circle C or on the circumference, “YES” is determined in the step S13, and the process proceeds to a step S15. Here, a duration during which the determination result is “YES” is measured, and “YES” may be determined at a time when the measurement result runs beyond a predetermined time (3 seconds, for example).

In the step S15, the message M1 is undisplayed (that is, is erased from the game screen), and in a step S17, the numerals 1-10 (10 buttons indicating them) are displayed in color on the basis of the information of the numeral button area 212 (position, size and selected flag). The game screen is as shown in FIG. 12 at this time point.

In a step S19, it is determined whether or not the barycenter is out of the center on the basis of the information of the central circle area 214 and the information of the position area 216, and if “NO”, the process shifts to a step S25. If “YES” in the step S19, the numerals 1-10 are undisplayed in a step S21, and then, it is determined whether or not the predetermine time elapses on the basis of the information of the time area 218 (start time and end time) in a step S23. If a time from the start time to the current time (elapsed time) reaches a predetermined time (30 seconds, for example), “YES” is determined in the step S23, and the process proceeds to a step S39 (described later). If the elapsed time is shorter than 30 seconds, “NO” is determined in the step S23, and the process returns to the step S5.

In the step S25, it is determined whether or not the numeral is selected on the basis of the information of the numeral button area 212 (position and size) and the operation data from the controller 22. In a step S27, it is determined whether or not the selected numeral is a correct numeral on the basis of the information of the numeral button area 212 (order and selected flag). If the selected numeral is the smallest numeral out of the unselected numerals, “YES” is determined in the step S27, and the process proceeds to a step S29.

In the step S29, the information of the numeral button area 212 is updated (the selected flag of the numeral is turned on), and the numeral is changed to the “selected numeral”. Then, in a step S31, it is determined whether or not all the numerals 1-10 are changed to the “selected numerals”, and if “NO”, the process shifts to a step S37 (described later). If “YES” in the step S31, it is considered that the game is to be cleared, and the process proceeds to a step S33. In the step S33, an elapsed time is calculated on the basis of the information of the time area 218, and the message M2 indicating the calculation result is displayed. The game screen is as shown in FIG. 15 at this time point. Then, the “balance testing game” is ended.

On the other hand, if the selected numeral is already “selected numeral” or is not the smallest numeral out of the unselected numerals, “NO” is determined in the step S27, and the process shifts to a step S35 to generate an alarm sound from the speaker 34a, then, the process proceeds to a step S37. In the step S37, it is determined whether or not the predetermined time elapses on the basis of the information of the time area 212, and if “NO”, the process returns to the step S7 while if “YES”, the process proceeds to a step S39. In the step S39, the number of “selected numerals” is calculated on the basis of the information of the numeral button area 212 (selected flag), and the message M3 indicating the calculation result is displayed. The game screen is as shown in FIG. 16 at this time point. Then, the “balance testing game” is ended.

As understood from the above description, in the game system 10 of this embodiment, the CPU 40 of the game apparatus 12 detects a coordinate position (designated position) designated on the screen of the monitor 34 on the basis of the signal from the controller 22 to be operated by the user (S7), detects a barycentric position of the user on the basis of the signal from the load controller 36 on which the user rides (S9), and performs processing in relation to a test of the balance function and the proceeding of the game on the basis of the detected coordinate position and the detected barycentric position (S13, S19, S25-S39). Thus, is it possible to test the balance function at a time of complex motions as if the player plays a game.

Additionally, in this embodiment, a game in which the numeral 1-10 dispersively arranged within the screen is selected in order is performed, but any game which is played by the user by operating the controller 22 can be performed in combination with the test.

Furthermore, in this embodiment, the “balance testing game” executed in the game system 10 is implemented according to the game program which allows the player to perform the game by utilizing the game system 10, but this can be implemented according to a training program being application software allowing the user to perform various training (or exercises) by utilizing the game system 10 without being restricted to the above description. In this case, the game apparatus 12 including a CPU 40 executing the training program functions as a training apparatus.

In the above description, the game system 10 is explained, but it may be applied to an information processing system including a coordinate input means for designating an arbitrary position within the screen according to an operation by the user and a barycentric position detecting means for detecting a barycentric position of the user. As coordinate input means, a touch panel, a mouse, etc. are applied other than a DPD (Direct Pointing Device), such as the controller 22. The barycentric position detecting means is a circuit or a program for calculating a barycentric position on the basis of signals from a plurality of load sensors, such as a load controller 36, but this may be a circuit or the program for processing an image from a video camera to estimate the barycentric position, for example.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A storage medium storing an information processing program, wherein
said information processing program causes a computer of an information processing apparatus to execute:
a coordinate position detecting step for detecting a coordinate position on a screen on the basis of a signal from a coordinate input means to be operated by a user,
a barycentric position detecting step for detecting a barycentric position of said user on the basis of a signal from a barycentric position detecting means, and
a processing step for performing predetermined processing on the basis of the coordinate position detected by said coordinate position detecting step and the barycentric position detected by said barycentric position detecting step.

2. A storage medium storing an information processing program according to claim 1, wherein
said processing step performs said predetermined processing on the basis of the coordinate position detected by said coordinate position detecting step when the barycentric position detected by said barycentric position detecting step is within a predetermined range.

3. A storage medium storing an information processing program according to claim 2, wherein
said information processing program causes said computer to further execute an image displaying step for displaying a designation image to be designated by said user when the barycentric position detected by said barycentric position detecting step is within the predetermined range.

4. A storage medium storing an information processing program according to claim 3, wherein
said processing step performs a specific process when the coordinate position detected by said coordinate position detecting step is within a range corresponding to the designation image displayed by said image displaying step.

5. A storage medium storing an information processing program according to claim 3, wherein
said information processing program causes said computer to further execute an image erasing step for erasing the designation image displayed by said image displaying step when the barycentric position detected by said barycentric position detecting step is off said predetermined range after said image displaying step displays said designation image.

6. A storage medium storing an information processing program according to claim 3, wherein
said image displaying step displays a plurality of designation images when the barycentric position detected by said barycentric position detecting step is within said predetermined range.

7. A storage medium storing an information processing program according to claim 6, wherein
said image displaying step displays said plurality of designation images to each of which a size is set when the barycentric position detected by said barycentric position detecting step is within said predetermined range.

8. A storage medium storing an information processing program according to claim 6, wherein
said image displaying step displays a plurality of designation images to each of which an order is set when the barycentric position detected by said barycentric position detecting step is within said predetermined range, and
said processing step performs said specific processing when the coordinate position detected by said coordinate position detecting step enters a range corresponding to said designation image in the order set to the designation images displayed by said image displaying step.

9. A storage medium storing an information processing program according to claim 2, wherein
said image displaying step displays an image corresponding to said predetermined range on said screen and said designation image around said image corresponding to said predetermined range.

10. A storage medium storing an information processing program according to claim 9, wherein
said image displaying step displays said image corresponding to said predetermined range at approximately a center of a predetermined region of said screen, and displays said designation image around said image corresponding to said predetermined range.

11. A storage medium storing an information processing program according to claim 1, wherein
said information processing program causes said computer to further execute a pointer displaying step for displaying a coordinate position pointer to indicate the coordinate position detected by said coordinate position detecting step on said screen.

12. A storage medium storing an information processing program according to claim 11, wherein
said pointer displaying step further displays a barycentric position pointer indicating the barycentric position detected by said barycentric position detecting step on said screen.

13. A storage medium storing an information processing program according to claim 12, wherein
said pointer displaying step displays said barycentric position pointer within the image corresponding to said predetermined range when the barycentric position detected by said barycentric position detecting step shows that the user is at balance.

14. An information processing apparatus, comprising:
a coordinate position detecting means for detecting a coordinate position on a screen on the basis of a signal from a coordinate input means to be operated by a user;
a barycentric position detecting means for detecting a barycentric position of said user on the basis of a signal from a barycentric position detecting means; and
a processing means for performing predetermined processing on the basis of the coordinate position detected by said coordinate position detecting means and the barycentric position detected by said barycentric position detecting means.

15. An information processing method, comprising:
a coordinate position detecting step for detecting a coordinate position on a screen on the basis of a signal from a coordinate input means to be operated by a user;
a barycentric position detecting step for detecting a barycentric position of said user on the basis of a signal from a barycentric position detecting means; and
a processing step for performing predetermined processing on the basis of the coordinate position detected by said coordinate position detecting step and the barycentric position detected by said barycentric position detecting step.
